(19) United States
(12) Patent Application Publication
(10) Pub. No.: US 2021/0118082 A1
(43) Pub. Date: Apr. 22, 2021

(54) SHARED VEHICLE MANAGING SYSTEM

(71) Applicant: HONDA MOTOR CO., LTD., Minato-ku, Tokyo (JP)

(72) Inventors: Toru KIMURA, Saitama (JP); Koji AOKI, Saitama (JP)

(21) Appl. No.: 17/253,270

(22) PCT Filed: May 30, 2019
(86) PCT No.: PCT/JP2019/021632

§ 371 Date: Dec. 17, 2020

(30) Foreign Application Priority Data
Jun. 22, 2018 (JP) 2018-118936

(51) Int. Cl. G06Q 50/30; G06Q 30/06; G06Q 10/02

(52) U.S. Cl. CPC G06Q 50/30; G06Q 10/02; G06Q 30/0645

(57) ABSTRACT

A shared vehicle managing system includes a plurality of user terminals configured to generate use application information, and a managing server connected to the user terminals via a network. The use application information includes information about a departure station, an arrival station, a scheduled departure time, and a scheduled arrival time. The managing server includes a reservation processing unit configured to allocate at least one shared vehicle to a use applicant based on the use application information, and a station information acquiring unit configured to acquire a remaining number of the shared vehicles in each station at a freely-selected time. The reservation processing unit executes a ride-sharing vehicle allocation process by determining a reservation confirmation person with whom the use applicant should share a ride based on the use application information.

### TECHNICAL FIELD

The present invention relates to a shared vehicle managing system.

### BACKGROUND ART

There is a shared vehicle managing system (car-sharing system) for renting a plurality of shared vehicles to a plurality of users. Such a shared vehicle managing system provides a one-way car sharing service (a leave-a-car type car sharing service) in which a user rents a shared vehicle at any station and then returns the shared vehicle to any other station (for example, Patent Document 1).

### PRIOR ART DOCUMENT(S)

### Patent Document(s)

Patent Document 1: JP2017-10189A

### SUMMARY OF THE INVENTION

### Task to be Accomplished by the Invention

However, such a one-way car sharing service has a problem that the shared vehicles are concentrated on some stations. If the shared vehicles are concentrated in this way, available shared vehicles run short in a departure station, which prevents the users from using the service. Further, if parking spaces run short in an arrival station, the users cannot select this arrival station as their destination. To prevent such a concentration of the shared vehicles, a service provider needs to transport the shared vehicles between the stations. Consequently, transportation costs occur.

In view of such a background, an object of the present invention is to suppress unevenness in the number of shared vehicles between the stations in the shared vehicle managing system.

### Means for Accomplishing the Task

To achieve such an object, one embodiment of the present invention provides a shared vehicle managing system (1) for renting a plurality of shared vehicles (2) located in a plurality of stations to a plurality of users, including: a plurality of user terminals (3) configured to generate use application information in response to an input operation by a use applicant, and a managing server (5) connected to the user terminals via a network (7), wherein the use application information includes information about a departure station, an arrival station, a scheduled departure time, and a scheduled arrival time, the managing server includes a reservation processing unit (14) configured to allocate at least one shared vehicle to the use applicant based on the use application information, and a station information acquiring unit (15) configured to acquire a remaining number of the shared vehicles in each station at a freely-selected time, the reservation processing unit executes a ride-sharing vehicle allocation process in a case where the remaining number of the shared vehicles in the departure station at the scheduled departure time of the use applicant is equal to or less than a first determination value, and in the ride-sharing vehicle allocation process, the reservation processing unit determines a reservation confirmation person with whom the use applicant should share a ride based on the use application information, the reservation confirmation person being a person whose reservation has already been confirmed.

According to this arrangement, in a case where the shared vehicles in the departure station selected by the use applicant are few at the scheduled departure time of the use applicant, the ride-sharing vehicle allocation process is executed to cause the use applicant to share the ride with the reservation confirmation person. By sharing the ride in this way, the use applicant can use the service and thus move to the arrival station without reducing the number of shared vehicles in the departure station. Accordingly, unevenness in the number of shared vehicles between the stations can be suppressed. Further, the use applicant can move to the arrival station even if the shared vehicle that can be allocated to the use applicant is not present in the departure station.

In the above arrangement, preferably, the use application information includes a tolerable departure period including a tolerable variation from the scheduled departure time, and in the ride-sharing vehicle allocation process, the reservation processing unit extracts a first group and selects the reservation confirmation person with whom the use applicant should share the ride from the first group, the first group being a group of reservation confirmation persons whose departure station is the same as the departure station of the use applicant and whose tolerable departure period overlaps with the tolerable departure period of the use applicant.

According to this arrangement, the reservation processing unit matches the use applicant with the reservation confirmation person based on the tolerable departure period, which is longer than the scheduled departure time. Accordingly, matching of the use applicant with the reservation confirmation person is more likely to succeed.

In the above arrangement, preferably, the use application information includes a tolerable arrival period including a tolerable variation from the scheduled arrival time, and in the ride-sharing vehicle allocation process, the reservation processing unit extracts a second group from the first group and selects the reservation confirmation person with whom the use applicant should share the ride from the second group, the second group being a group of the reservation confirmation persons whose arrival station is the same as the arrival station of the use applicant and whose tolerable arrival period overlaps with the tolerable arrival period of the use applicant.

According to this arrangement, the reservation processing unit matches the use applicant with the reservation confirmation person whose departure station and arrival station are the same as those of the use applicant. Accordingly, the reservation confirmation person can move from the departure station to the arrival station according to the original travel route.

In the above arrangement, preferably, the use application information includes a tolerable arrival period including a tolerable variation from the scheduled arrival time, and in the ride-sharing vehicle allocation process, the reservation processing unit extracts a third group from the first group and selects the reservation confirmation person with whom the use applicant should share the ride from the third group, the third group being a group of the reservation confirmation persons whose arrival station is different from the arrival station of the use applicant and who can drop by the arrival station of the use applicant in the tolerable arrival period of the use applicant and arrive at the arrival station of the reservation confirmation persons in the tolerable arrival period of the reservation confirmation persons.

According to this arrangement, the reservation processing unit matches the use applicant with the reservation confirmation person whose departure station is the same as that of the user applicant but whose arrival station is different from that of the use applicant. The reservation confirmation person drops by the arrival station of the use applicant, and then moves to his/her own arrival station.

In the above arrangement, preferably, the use application information includes a tolerable departure period including a tolerable variation from the scheduled departure time and a tolerable arrival period including a tolerable variation from the scheduled arrival time, and in the ride-sharing vehicle allocation process, the reservation processing unit selects the reservation confirmation person with whom the use applicant should share the ride from a group including reservation confirmation persons whose departure station is different from the departure station of the use applicant, whose arrival station is different from the arrival station of the use applicant, who can drop by the departure station of the use applicant in the tolerable departure period of the use applicant, who can drop by the arrival station of the use applicant in the tolerable arrival period of the use applicant, and who can arrive at the arrival station of the reservation confirmation persons in the tolerable arrival period of the reservation confirmation persons.

According to this arrangement, the reservation processing unit matches the use applicant with the reservation confirmation person whose departure station and arrival station are different from those of the use applicant. The reservation confirmation person drops by the departure station and the arrival station of the use applicant in order, and then moves to his/her own arrival station.

In the above arrangement, preferably, the use application information includes ride-sharing approval information for approving ride-sharing, and the reservation processing unit executes the ride-sharing vehicle allocation process in a case where the ride-sharing approval information of the use applicant is present, and selects the reservation confirmation person with whom the use applicant should share the ride from reservation confirmation persons whose ride-sharing approval information indicates approval of the ride-sharing.

According to this arrangement, the use applicant and the reservation confirmation person can reflect their intentions in the ride-sharing vehicle allocation process. Accordingly, even the use applicant and the reservation confirmation person who do not want to share the ride can relievedly use a car sharing service provided by the shared vehicle managing system.

In the above arrangement, preferably, the managing server is configured to give incentives to the use applicant and the reservation confirmation person whose ride-sharing has been confirmed.

According to this arrangement, the users are more likely to approve the ride-sharing. Accordingly, the population of the matching can be increased, so that the frequency of successful matching can be improved.

In the above arrangement, preferably, wherein the use application information further includes information about a number of driving approvers, the reservation processing unit executes a divisional vehicle allocation process in a case where the remaining number of the shared vehicles in the departure station at the scheduled departure time of the use applicant is equal to or more than a second determination value and the remaining number of the shared vehicles in the arrival station at the scheduled arrival time of the use applicant is equal to or less than a third determination value, and in the divisional vehicle allocation process, the reservation processing unit allocates the plurality of shared vehicles in the departure station to the use applicant in a case where the number of the driving approvers is plural.

According to this arrangement, the shared vehicle in the departure station can be moved to the arrival station by using an accompanying person of the use applicant. Accordingly, the remaining number of shared vehicles in the arrival station can increase.

Another embodiment of the present invention provides a shared vehicle managing system for renting a plurality of shared vehicles located in a plurality of stations to a plurality of users, including: a plurality of user terminals configured to generate use application information in response to an input operation by a use applicant, and a managing server connected to the user terminals via a network, wherein the use application information includes information about a departure station, an arrival station, a scheduled departure time, a scheduled arrival time, and a number of driving approvers, the managing server includes a reservation processing unit configured to allocate at least one shared vehicle to the use applicant based on the use application information, and a station information acquiring unit configured to acquire a remaining number of the shared vehicles in each station at a freely-selected time, the reservation processing unit executes a divisional vehicle allocation process in a case where the remaining number of the shared vehicles in the departure station at the scheduled departure time of the use applicant is equal to or more than a first determination value and the remaining number of the shared vehicles in the arrival station at the scheduled arrival time of the use applicant is equal to or less than a second determination value, and in the divisional vehicle allocation process, the reservation processing unit allocates the plurality of shared vehicles in the departure station to the use applicant in a case where the number of the driving approvers is plural.

According to this arrangement, the shared vehicle in the departure station can be moved to the arrival station by using an accompanying person of the use applicant. Accordingly, the remaining number of shared vehicles in the arrival station can increase.

In the above arrangement, preferably, the use application information further includes divisional approval information for approving a divisional ride, and in the divisional vehicle allocation process, the reservation processing unit allocates the plurality of shared vehicles in the departure station to the use applicant in a case where the number of the driving approvers is plural and the divisional approval information is present.

According to this arrangement, the use applicant can reflect his/her intention in the divisional vehicle allocation process. Accordingly, the use applicant who does not want to take the divisional ride can use the car sharing service provided by the shared vehicle managing system.

In the above arrangement, preferably, the managing server is configured to give an incentive to the use applicant who takes a divisional ride.

According to this arrangement, the users are more likely to approve the divisional ride, and thus the unevenness of the number of shared vehicles can be suppressed.

### Effect of the Invention

Thus, according to the above arrangements, it is possible to suppress unevenness in the number of shared vehicles between the stations in the shared vehicle managing system.

### BRIEF DESCRIPTION OF THE DRAWING(S)

FIG. 1 is a block diagram of a shared vehicle managing system according to an embodiment;

FIG. 2 is a flowchart of a reservation process;

FIG. 3 is a flowchart of a ride-sharing vehicle allocation process;

FIG. 4 is a flowchart of the ride-sharing vehicle allocation process;

FIG. 5 is a flowchart of the ride-sharing vehicle allocation process; and

FIG. 6 is a flowchart of a divisional vehicle allocation process.

### MODE(S) FOR CARRYING OUT THE INVENTION

In the following, with reference to the drawings, an embodiment of a shared vehicle managing system 1 will be described. The shared vehicle managing system 1 is managed by a group that owns a plurality of shared vehicles 2, and is configured to provide a service (namely, a car-sharing service) for renting the plurality of shared vehicles 2 to a plurality of users registered in advance. The abovementioned group may be a company, a government office, a sports club, a nursing home, a shopping center, a car-sharing provider, or the like. The group owns a plurality of stations for parking the shared vehicles 2. Each station has a plurality of parking spaces where the plurality of shared vehicles 2 can be parked. User identification numbers are set for all the users, shared vehicle identification numbers are set for all the shared vehicles 2, and station identification numbers are set for all the stations. These numbers are respectively registered in the shared vehicle managing system 1. The shared vehicle managing system 1 is configured to accept a use application from each user, and allocates a shared vehicle 2 to the user who has made the use application (reservation).

Each shared vehicle 2 may be a gasoline vehicle or a diesel vehicle that uses fuel such as gasoline or light oil, or may be an electric vehicle that uses electric power of a battery.

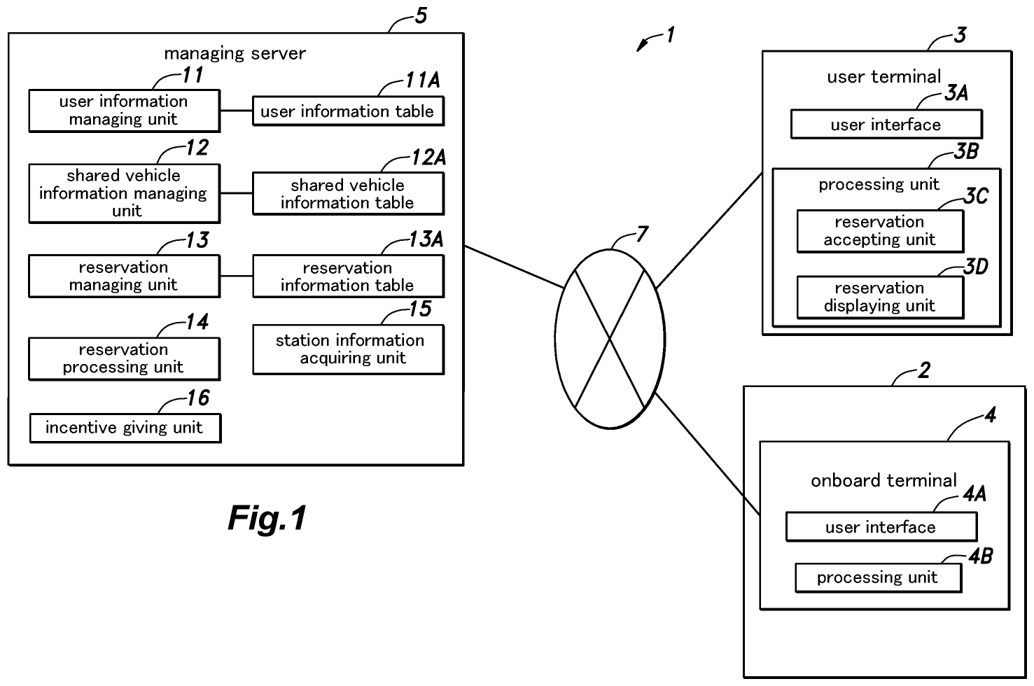

As shown in FIG. 1, the shared vehicle managing system 1 includes a plurality of user terminals 3, a plurality of onboard terminals 4 respectively mounted on the plurality of shared vehicles 2, and a managing server 5. The plurality of user terminals 3, the plurality of onboard terminals 4, and the managing server 5 are connected to each other via a network 7. For example, the network 7 is the Internet. Each user owns the user terminal 3. The managing server 5 may be a server provided in the building of the group that manages the shared vehicle managing system 1, or may be a cloud server.

Each user terminal 3 includes a user interface 3A configured to display an input screen and a message and to accept an input operation by each user, and a processing unit 3B composed of an arithmetic unit, memory, and the like. For example, the user terminal 3 consists of a smartphone, a mobile phone, or a personal computer. The processing unit 3B includes a reservation accepting unit 3C and a reservation displaying unit 3D. The reservation accepting unit 3C is configured to transmit use application information (reservation application information), which is generated in response to the input operation on the user interface 3A by the user, to the managing server 5. The reservation displaying unit 3D is configured to cause the user interface 3A to display a reservation confirmation screen upon receiving reservation confirmation information from the managing server 5. In the present embodiment, the reservation accepting unit 3C and the reservation displaying unit 3D respectively consist of software executed in the processing unit 3B.

The use application information includes the name of the use applicant (the user identification number), the name of the departure station (the station identification number), the name of the arrival station (the station identification number), the scheduled departure time (the use start time), the scheduled arrival time (the use end time), ride-sharing approval information, divisional approval information, the number of driving approvers, a tolerable departure period, and a tolerable arrival period.

The ride-sharing approval information represents an intention of each user about ride-sharing, and is set to either Yes (approval) or No (disapproval). The divisional approval information represents an intention of the user about a divisional ride, and is set to either Yes (approval) or No (disapproval). Here, “ride-sharing” means that the use applicant shares a ride with another user in the shared vehicle 2 allocated to another user. Further, “divisional ride” means that a group (accompanying persons of the use applicant) moving with the use applicant is divided into a plurality of subgroups, and the subgroups board the shared vehicles 2 separately.

The number of driving approvers represents the number of users (except for the use applicant) who approve of driving the shared vehicle 2 in the group traveling with the use applicant. In a case where the number of driving approvers is equal to or more than one, the shared vehicle 2 may be allocated to one or more driving approvers in the group of the use applicant. In a case where the divisional approval information is set to Yes, the number of driving approvers is set to a value equal to or more than one. In a case where the divisional approval information is set to No, the number of driving approvers is set to zero. The driving approvers may be required to be the users registered in the shared vehicle managing system 1 in advance.

The tolerable departure period is a period indicating the departure time each user can tolerate, and the tolerable arrival period is a period indicating the arrival time the user can tolerate. Only in a case where the ride-sharing approval information is set to Yes, the tolerable departure period and the tolerable arrival period are set. The tolerable departure period may be set as the user inputs the start time and the end time of the tolerable departure period, or may be set based on the scheduled departure time and a tolerable variation therefrom, which are input by the user. Similarly, the tolerable arrival period may be set as the user inputs the start time and the end time of the tolerable arrival period, or may be set based on the scheduled arrival time and a tolerable variation therefrom, which are input by the user.

The reservation accepting unit 3C is configured to cause the user interface 3A to display a reservation accepting screen. The reservation accepting screen includes input boxes and check boxes, which are respectively related to items of the use application information. In the present embodiment, the reservation accepting screen requests inputs of the name of the departure station (the station identification number), the name of the arrival station (the station identification number), the scheduled departure time, the scheduled arrival time, the ride-sharing approval information, and the divisional approval information. Further, in a case where information corresponding to Yes is input as the ride-sharing approval information, the reservation accepting screen further requests inputs of the tolerable departure period and the tolerable arrival period. Further, in a case where information corresponding to Yes is input as the divisional approval information, the reservation accepting screen further requests inputs of the number of driving approvers and the user identification number of each accompanying person who approves of driving the shared vehicle 2. In another embodiment, the input of the user identification number of the accompanying person who approves of driving the shared vehicle 2 may be omitted.

The reservation accepting unit 3C is configured to generate the use application information in response to the input operation by each user. In a case where the ride-sharing approval information is set to No, the scheduled departure time may be input as the tolerable departure period, and the scheduled arrival time may be input as the tolerable arrival period. Further, in a case where the divisional approval information is set to No, zero may be input as the number of driving approvers. The reservation accepting unit 3C is configured to transmit the generated use application information to the managing server 5.

After each user terminal 3 receives reservation information from the managing server 5, the reservation displaying unit 3D causes the user interface 3A to display the reservation confirmation screen. The reservation information includes the user name (the user identification number), the name of the departure station (the station identification number), the name of the arrival station (the station identification number), the scheduled departure time, the scheduled arrival time, the presence/absence of the ride-sharing, the presence/absence of the divisional ride, and information for identifying the shared vehicle 2 to be boarded. In a case where the divisional ride is present, the reservation information includes plural pieces of information for identifying the shared vehicle 2 to be boarded.

Each onboard terminal 4 includes a user interface 4A configured to display an input screen and a message and to accept an input by each user, and a processing unit 4B composed of an arithmetic unit, memory, and the like. For example, the onboard terminal 4 is a vehicle navigation device.

The managing server 5 is a computer including a central processing unit, memory, a hard disk, and the like. The managing server 5 includes a user information managing unit 11 configured to hold information about each user, a shared vehicle information managing unit 12 configured to hold shared vehicle information (vehicle information) about each shared vehicle 2, a reservation managing unit 13 configured to manage the use application information and the reservation information corresponding thereto, a reservation processing unit 14 configured to generate the reservation information based on the use application information, a station information acquiring unit 15 configured to manage information about the remaining number of shared vehicles 2 and the number of unoccupied parking spaces in each station, and an incentive giving unit 16.

The user information managing unit 11 has a user information table 11A. The user information table 11A stores information about each user as user information. The user information includes the user identification number and the user name.

The shared vehicle information managing unit 12 has a shared vehicle information table 12A. The shared vehicle information table 12A stores the vehicle information related to each shared vehicle 2 as the shared vehicle information. The shared vehicle information includes the shared vehicle identification number, the station identification number of the station where the shared vehicle 2 is currently located, the use history of the shared vehicle 2, information about a prospective position of the shared vehicle 2, and the specification of the shared vehicle 2.

The reservation processing unit 14 is configured to execute a reservation process described later based on the use application information so as to generate the reservation information. The generated reservation information is stored in a reservation information table 13A of the reservation managing unit 13. The reservation information includes the application number, the success/failure of the use application, the user identification number, the departure station, the arrival station, the transit station, the scheduled departure time, the scheduled arrival time, the presence/absence of the ride-sharing, the presence/absence of the divisional ride, information about a ride-sharing partner, and information about a shared vehicle number of the shared vehicle 2 to be used (or information about a plurality of shared vehicle numbers in a case of the divisional ride). The reservation managing unit 13 is configured to transmit the reservation information to the user terminal 3 of the use applicant in response to the use application by the use applicant.

The station information acquiring unit 15 is configured to acquire the remaining number of shared vehicles 2 and the number of unoccupied parking spaces in any station as station information. With regard to each station, the sum of the remaining number of shared vehicles 2 and the number of unoccupied parking spaces is equal to the total number of parking spaces in this station. Accordingly, if the remaining number of shared vehicles 2 in each station is identified, the number of unoccupied parking spaces therein can be also identified. For example, the current remaining number of shared vehicles 2 in each station can be acquired based on the positions of the shared vehicles 2 acquired by GPS or the like. Alternatively, the current remaining number of shared vehicles 2 in each station can be acquired by detecting the presence of shared vehicles 2 by sensors installed in the parking spaces of each station. The remaining number of shared vehicles 2 and the number of unoccupied parking spaces in each station at a future time can be acquired based on the current remaining number of shared vehicles 2 in this station and each piece of the reservation information stored in the reservation information table 13A.

The incentive giving unit 16 is configured to extract each user who shares the ride and takes the divisional ride based on each piece of the reservation information stored in the reservation information table 13A, and to add incentive information to the user information about this user. For example, the incentive may be a reduction in the service fee at the current use of the service, a coupon that can be used at the next use of the service, granting of a point, or the like.

Upon receiving the use application information, the reservation processing unit 14 executes the reservation process based on the use application information, the reservation information stored in the reservation information table 13A, the shared vehicle information stored in the shared vehicle information table 12A, and the station information acquired by the station information acquiring unit 15, thereby determining the shared vehicle 2 to be allocated to each user.

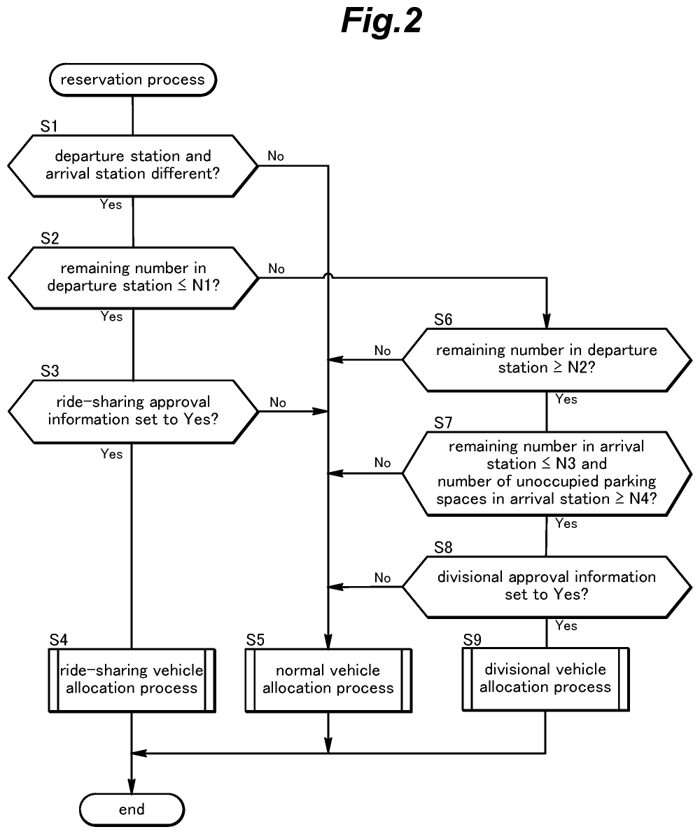

As shown in FIG. 2, in the reservation process, the reservation processing unit 14 first determines whether the departure station and the arrival station of the use applicant are different based on the use application information (S1). In a case where the departure station and the arrival station of the use applicant are the same (the determination in S1 is No), the reservation processing unit 14 executes a normal vehicle allocation process (S5). In the normal vehicle allocation process, the reservation processing unit 14 determines whether a shared vehicle that can be allocated to the use applicant is present based on the use application information, the shared vehicle information, and the information about the unoccupied parking spaces at the scheduled arrival time acquired by the station information acquiring unit 15. In a case where the shared vehicle that can be allocated to the use applicant is present, the reservation processing unit 14 confirms the reservation. In a case where no shared vehicle that can be allocated to the use applicant is present, the reservation processing unit 14 cause the reservation to fail.

In a case where the departure station and the arrival station of the use applicant are different (determination in S1 is Yes), the reservation processing unit 14 determines whether the remaining number of the shared vehicles 2 (hereinafter abbreviated as “the remaining number”) in the departure station at the scheduled departure time of the use applicant is equal to or less than a first determination value N1 (S2). The remaining number in the departure station at the scheduled departure time thereof is acquired by the station information acquiring unit 15. The first determination value N1 is a prescribed value set for each departure station, and is used to determine whether the remaining number is small. For example, the first determination value N1 is set to 3 in a case where the total number of parking spaces is 10.

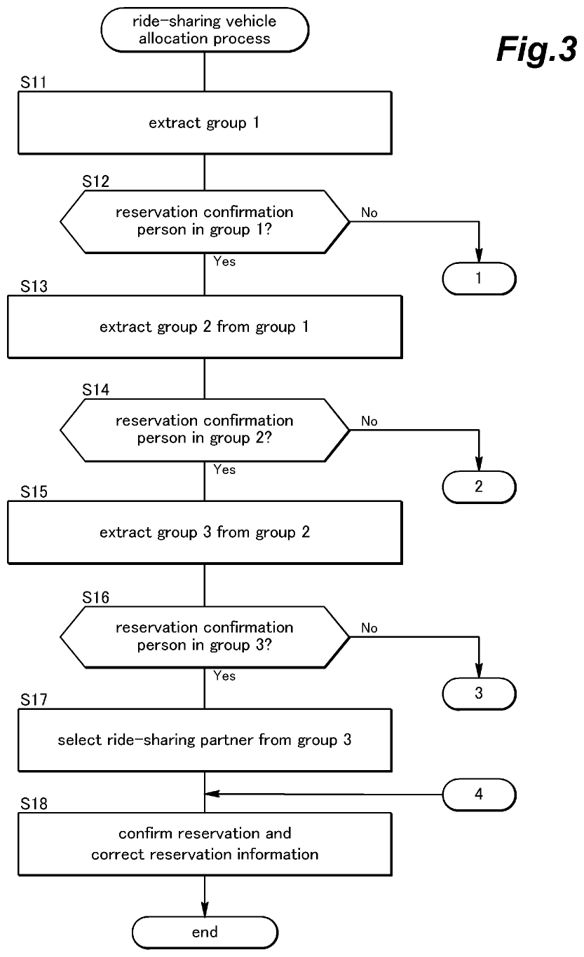

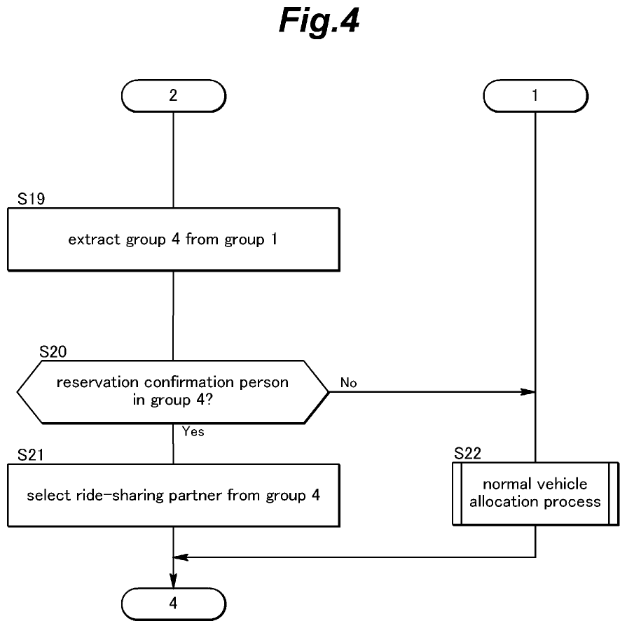

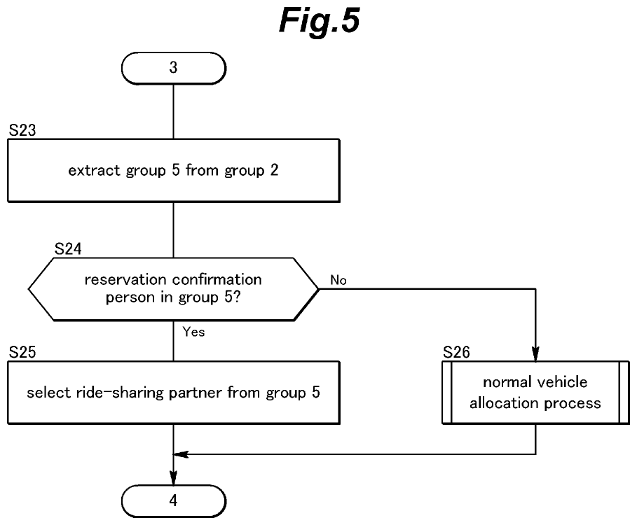

In a case where the determination in S2 is Yes, the reservation processing unit 14 determines whether the ride-sharing approval information about the use applicant is set to Yes (S3). In a case where the ride-sharing approval information about the use applicant is set to Yes, the reservation processing unit 14 executes a ride-sharing vehicle allocation process described later (S4). The ride-sharing vehicle allocation process is executed based on flowcharts shown in FIGS. 3 to 5. In a case where the ride-sharing approval information about the use applicant is set to No (the determination in S3 is No), the reservation processing unit 14 executes the normal vehicle allocation process (S5).

In a case where the determination in S2 is No, the reservation processing unit 14 determines whether the remaining number in the departure station at the scheduled departure time of the use applicant is equal to or more than a second determination value N2 (S6). The second determination value N2 is a prescribed value set for each departure station, and is used to determine whether the remaining number is large. The second determination value N2 is set to a value larger than the first determination value N1. For example, the second determination value N2 is set to 7 in a case where the total number of parking spaces is 10.

In a case where the determination in S6 is Yes, the reservation processing unit 14 determines whether the remaining number in the arrival station at the scheduled arrival time of the use applicant is equal to or less than a third determination value N3 and the number of unoccupied parking spaces in the arrival station at the scheduled arrival time of the use applicant is equal to or more than a fourth determination value N4 (S7). The third determination value N3 is a prescribed value set for each arrival station, and is used to determine whether the remaining number is small. The fourth determination value N4 is a prescribed value set for each arrival station, and is used to determine whether the number of unoccupied parking spaces is large. For example, the third determination value N3 may be set to 3 and the fourth determination value N4 may be set to 2 in a case where the total number of parking spaces is 10.

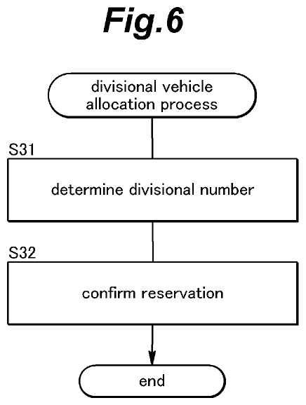

In a case where the determination in S7 is Yes, the reservation processing unit 14 determines whether the divisional approval information about the use applicant is set to Yes (S8). In a case where the divisional approval information about the use applicant is set to Yes, the reservation processing unit 14 executes a divisional vehicle allocation process described later (S9). The divisional vehicle allocation process is executed based on a flowchart shown in FIG. 6. In a case where the determination in any one of S6, S7, and S8 is No, the reservation processing unit 14 executes the normal vehicle allocation process (S5).

In the ride-sharing vehicle allocation process, the reservation processing unit 14 selects a reservation confirmation person with whom the use applicant should share the ride. As shown in FIGS. 3 to 5, in the ride-sharing vehicle allocation process, the reservation processing unit 14 first extracts a group 1 based on the reservation information stored in the reservation information table 13A (S11). The group 1 is a group of reservation confirmation persons whose ride-sharing approval information is set to Yes. Here, “reservation confirmation person” means a person (user) whose reservation has already been confirmed when the reservation process for the use applicant is executed.

Next, the reservation processing unit 14 determines whether one or more reservation confirmation persons are present in the group 1 (S12). In a case where one or more reservation confirmation persons are present in the group 1 (the determination in S12 is Yes), the reservation processing unit 14 extracts a group 2 from the group 1 based on the reservation information and the use application information (S13). The group 2 is a group of the reservation confirmation persons whose departure station is the same as that of the use applicant and whose tolerable departure period at least partially overlaps with that of the use applicant. The group 2 includes the reservation confirmation persons who depart from the departure station of the use applicant at a time relatively near the departure time of the use applicant.

Next, the reservation processing unit 14 determines whether one or more reservation confirmation persons are present in the group 2 (S14). In a case where one or more reservation confirmation persons are present in the group 2 (the determination in S14 is Yes), the reservation processing unit 14 extracts a group 3 from the group 2 based on the reservation information and the use application information (S15). The group 3 is a group of the reservation confirmation persons whose arrival station is the same as that of the use applicant and whose tolerable arrival period at least partially overlaps with that of the use applicant. The group 3 includes the reservation confirmation persons who depart from the departure station of the use applicant at a time relatively near the departure time of the use applicant and arrive at the arrival station of the use applicant at a time relatively near the arrival time of the use applicant.

Next, the reservation processing unit 14 determines whether one or more reservation confirmation persons are present in the group 3 (S16). In a case where one or more reservation confirmation persons are present in the group 3 (the determination in S16 is Yes), the reservation processing unit 14 selects one reservation confirmation person as a ride-sharing partner from the group 3 (S17). Various methods can be applied to a method for selecting the one reservation confirmation person as the ride-sharing partner from the group 3. For example, the reservation confirmation person whose scheduled departure time is the closest to that of the use applicant may be selected as the ride-sharing partner based on the scheduled departure time. Alternatively, the reservation confirmation person whose scheduled arrival time is the closest to that of the use applicant may be selected as the ride-sharing partner based on the scheduled arrival time. Alternatively, the reservation confirmation person may be selected as the ride-sharing partner based on the number of users who board the shared vehicle 2 with the reservation confirmation person, the number of times the reservation confirmation person has previously used the ride-sharing, or the like.

Next, the reservation processing unit 14 generates the reservation information about the use applicant based on the use application information about the use applicant and the reservation information about the reservation confirmation person as the ride-sharing partner, thereby confirming the reservation of the use applicant (S18). The scheduled departure time and the scheduled arrival time included in the reservation information about the use applicant are set based on the scheduled departure time and the scheduled arrival time of the reservation confirmation person as the ride-sharing partner and the tolerable departure period and the tolerable arrival period of the use applicant. For example, in a case where the scheduled departure time of the ride-sharing partner is present within the tolerable departure period of the use applicant, the reservation processing unit 14 sets the scheduled departure time of the ride-sharing partner as the scheduled departure time of the use applicant in the reservation information. Further, in a case where the scheduled departure time of the ride-sharing partner is not present within the tolerable departure period of the use applicant, the reservation processing unit 14 sets a closest time as the scheduled departure time of the use applicant in the reservation information. The closest time is a time closest to the scheduled departure time of the ride-sharing partner within the tolerable departure period of the use applicant. In this case, the reservation processing unit 14 corrects the scheduled departure time in the reservation information about the reservation confirmation person as the ride-sharing partner based on the scheduled departure time in the reservation information about the use applicant. The reservation processing unit 14 sets the scheduled arrival time in the reservation information about the use applicant like setting the scheduled departure time therein. The departure station and the arrival station in the use application information about the use applicant are set to the departure station and the arrival station in the reservation information about the use applicant. Further, the information corresponding to the presence of the ride-sharing is set to the reservation information about the use applicant and the reservation confirmation person as the ride-sharing partner.

In a case where no reservation confirmation person is present in the group 1 (the determination in S12 is No), the reservation processing unit 14 executes a normal vehicle allocation process (S22). This normal vehicle allocation process is the same as the normal vehicle allocation process in S5.

In a case where no reservation confirmation person is present in the group 2 (the determination in S14 is No), the reservation processing unit 14 extracts a group 4 from the group 1 based on the reservation information and the use application information (S19). The group 4 is a group of the reservation confirmation persons who satisfy all of the following conditions (1) to (4).

condition (1) The departure station of the reservation confirmation person is different from that of the use applicant.
condition (2) The reservation confirmation person can drop by the departure station of the use applicant in the tolerable departure period of the use applicant.
condition (3) The reservation confirmation person can drop by the arrival station of the use applicant in the tolerable arrival period of the use applicant.
condition (4) The reservation confirmation person can arrive at his/her own arrival station in his/her own tolerable arrival period.
The group 4 includes the reservation confirmation person who can pick up the use applicant on his/her own travel route.

Next, the reservation processing unit 14 determines whether one or more reservation confirmation persons are present in the group 4 (S20). In a case where one or more reservation confirmation persons are present in the group 4 (the determination in S20 is Yes), the reservation processing unit 14 selects one reservation confirmation person as the ride-sharing partner from the group 4 (S21). Various methods can be applied to a method for selecting the one reservation confirmation person as the ride-sharing partner from the group 4. For example, the reservation confirmation person whose departure station is the closest to that of the use applicant may be selected as the ride-sharing partner. After selecting the ride-sharing partner in S21, the reservation processing unit 14 generates the reservation information about the use applicant and confirms the reservation of the use applicant (S18). In a case where no reservation confirmation person is present in the group 4 (the determination in S20 is No), the reservation processing unit 14 executes the normal vehicle allocation process (S22).

In a case where no reservation confirmation person is present in the group 3 (the determination in S16 is No), the reservation processing unit 14 extracts a group 5 from the group 2 based on the reservation information and the use application information (S23). The group 5 is a group of the reservation confirmation persons who satisfy both the following conditions (1) and (2).

condition (1) The reservation confirmation person can drop by the arrival station of the use applicant in the tolerable arrival period of the use applicant.
condition (2) The reservation confirmation person can arrive at his/her own arrival station in his/her own tolerable arrival period.
The group 5 includes the reservation confirmation person whose departure station is the same as that of the use applicant and who can drop by the arrival station of the use applicant on his/her own travel route.

Next, the reservation processing unit 14 determines whether one or more reservation confirmation persons are present in the group 5 (S24). In a case where one or more reservation confirmation persons are present in the group 5 (the determination in S24 is Yes), the reservation processing unit 14 selects one reservation confirmation person as the ride-sharing partner from the group 5 (S25). Various methods can be applied to a method for selecting the one reservation confirmation person as the ride-sharing partner from the group 5. For example, the reservation confirmation person whose arrival station is the closest to that of the use applicant may be selected as the ride-sharing partner. After selecting the ride-sharing partner in S25, the reservation processing unit 14 generates the reservation information about the use applicant and confirms the reservation of the use applicant (S18). In a case where no reservation confirmation person is present in the group 5 (the determination in S24 is No), the reservation processing unit 14 executes the normal vehicle allocation process (S26). The normal vehicle allocation process in S26 is the same as the normal vehicle allocation process in S5.

In the divisional vehicle allocation process, the reservation processing unit 14 divides the group including the use applicant into a plurality of subgroups, and allocates the shared vehicles 2 to the use applicant such that the number of allocated shared vehicles 2 corresponds to the divisional number of the group (namely, the number of subgroups). As shown in FIG. 6, in the divisional vehicle allocation process, the reservation processing unit 14 first determines the divisional number of the group including the use applicant based on the number of driving approvers in the use application information (S31). The divisional number is a number equal to or more than 2, and is set to be equal to or less than the number of driving approvers. The reservation processing unit 14 determines the divisional number based on the number of driving approvers, the number of available shared vehicles 2 in the departure station at the scheduled departure time of the use applicant, the number of unoccupied parking spaces in the arrival station at the scheduled arrival time of the use applicant. In another embodiment, the reservation processing unit 14 may fix the divisional number to 2 regardless of the number of driving approvers or the like.

Next, the reservation processing unit 14 generates the reservation information by allocating the shared vehicles 2 to the use applicant such that the number of allocated shared vehicles 2 is the same as the divisional number, and confirms the reservation of the use applicant (S32). The departure station, the arrival station, the scheduled departure time, and the scheduled arrival time in the reservation information are the same as those in the use application information.

The function of the car sharing service provided by the shared vehicle managing system 1 with the abovementioned configuration will be described. In a case where the remaining number in the departure station at the scheduled departure time of the use applicant is small (equal to or less than the first determination value N1), the reservation processing unit 14 of the shared vehicle managing system 1 executes the ride-sharing vehicle allocation process. In the ride-sharing vehicle allocation process, the reservation processing unit 14 matches the reservation confirmation person as the ride-sharing partner, who can satisfy the conditions set by the use applicant, with the use applicant. Accordingly, the use applicant can move to the arrival station without reducing the remaining number in the departure station. Accordingly, it is possible to prevent the remaining number in the departure station from decreasing excessively. Further, the use applicant can move to the arrival station even if the shared vehicle 2 that can be allocated to the use applicant is not present in the departure station.

Further, the reservation processing unit 14 of the shared vehicle managing system 1 executes the divisional vehicle allocation process in a case where the remaining number in the departure station at the scheduled departure time of the use applicant is enough (equal to or more than the second determination value N2), the remaining number in the arrival station at the scheduled arrival time of the use applicant is small (equal to or less than the third determination value N3), and the number of unoccupied parking spaces in the arrival station at the scheduled arrival time of the use applicant is enough (equal to or more than the fourth determination value N4). In the divisional vehicle allocation process, the reservation processing unit 14 divides the group including the use applicant into a plurality of subgroups and allocates the shared vehicle to each subgroup. Accordingly, a plurality of shared vehicles move from the departure station to the arrival station, so that the remaining number in the arrival station can be increased.

The shared vehicle managing system 1 can suppress the unevenness in the number of shared vehicles 2 between the stations by proposing the ride-sharing and the divisional ride to the use applicant. The reservation processing unit 14 executes the ride-sharing vehicle allocation process and the divisional vehicle allocation process based on the ride-sharing approval information and the divisional approval information included in the use application information. Accordingly, even the users who do not want to share the ride and take the divisional ride can relievedly use the car sharing service.

The shared vehicle managing system 1 gives incentives to the users who approve the ride-sharing and the divisional ride. Accordingly, the users are more likely to approve the ride-sharing and the divisional ride, so that the frequency of successful matching can be improved by increasing the population of the matching for the ride-sharing.

In the ride-sharing vehicle allocation process, the reservation processing unit 14 performs the matching based on the tolerable departure period longer than the scheduled departure time, so that the frequency of successful matching can be improved.

In the ride-sharing vehicle allocation process, the reservation processing unit 14 matches the use applicant with the reservation confirmation person whose departure station and arrival station are the same as those of the use applicant. Accordingly, the reservation confirmation person can move from the departure station to the arrival station according to the original travel route.

Concrete embodiments of the present invention have been described in the foregoing, but the present invention should not be limited by the foregoing embodiments and various modifications and alterations are possible within the scope of the present invention. The station information acquiring unit 15 can acquire the remaining number in each station based on various known methods. Further, in the normal vehicle allocation process, available shared vehicles 2 can be allocated to the use applicant based on various known methods.

### Glossary of Terms

1: shared vehicle managing system
2: shared vehicle
3: user terminal
4: onboard terminal
5: managing server
7: network
11: user information managing unit
11A: user information table
12: shared vehicle information managing unit
12A: shared vehicle information table
13: reservation managing unit
13A: reservation information table
14: reservation processing unit
15: station information acquiring unit
16: incentive giving unit

1. A shared vehicle managing system for renting a plurality of shared vehicles located in a plurality of stations to a plurality of users, comprising:
a plurality of user terminals configured to generate use application information in response to an input operation by a use applicant, and
a managing server connected to the user terminals via a network,
wherein the use application information includes information about a departure station, an arrival station, a scheduled departure time, and a scheduled arrival time,
the managing server includes a reservation processing unit configured to allocate at least one shared vehicle to the use applicant based on the use application information, and a station information acquiring unit configured to acquire a remaining number of the shared vehicles in each station at a freely-selected time,
the reservation processing unit executes a ride-sharing vehicle allocation process in a case where the remaining number of the shared vehicles in the departure station at the scheduled departure time of the use applicant is equal to or less than a first determination value, and
in the ride-sharing vehicle allocation process, the reservation processing unit determines a reservation confirmation person with whom the use applicant should share a ride based on the use application information, the reservation confirmation person being a person whose reservation has already been confirmed.

2. The shared vehicle managing system according to claim 1, wherein the use application information includes a tolerable departure period including a tolerable variation from the scheduled departure time, and
in the ride-sharing vehicle allocation process, the reservation processing unit extracts a first group and selects the reservation confirmation person with whom the use applicant should share the ride from the first group, the first group being a group of reservation confirmation persons whose departure station is the same as the departure station of the use applicant and whose tolerable departure period overlaps with the tolerable departure period of the use applicant.

3. The shared vehicle managing system according to claim 2, wherein the use application information includes a tolerable arrival period including a tolerable variation from the scheduled arrival time, and
in the ride-sharing vehicle allocation process, the reservation processing unit extracts a second group from the first group and selects the reservation confirmation person with whom the use applicant should share the ride from the second group, the second group being a group of the reservation confirmation persons whose arrival station is the same as the arrival station of the use applicant and whose tolerable arrival period overlaps with the tolerable arrival period of the use applicant.

4. The shared vehicle managing system according to claim 2, wherein the use application information includes a tolerable arrival period including a tolerable variation from the scheduled arrival time, and
in the ride-sharing vehicle allocation process, the reservation processing unit extracts a third group from the first group and selects the reservation confirmation person with whom the use applicant should share the ride from the third group, the third group being a group of the reservation confirmation persons whose arrival station is different from the arrival station of the use applicant and who can drop by the arrival station of the use applicant in the tolerable arrival period of the use applicant and arrive at the arrival station of the reservation confirmation persons in the tolerable arrival period of the reservation confirmation persons.

5. The shared vehicle managing system according to claim 1, wherein the use application information includes a tolerable departure period including a tolerable variation from the scheduled departure time and a tolerable arrival period including a tolerable variation from the scheduled arrival time, and
in the ride-sharing vehicle allocation process, the reservation processing unit selects the reservation confirmation person with whom the use applicant should share the ride from a group including reservation confirmation persons whose departure station is different from the departure station of the use applicant, whose arrival station is different from the arrival station of the use applicant, who can drop by the departure station of the use applicant in the tolerable departure period of the use applicant, who can drop by the arrival station of the use applicant in the tolerable arrival period of the use applicant, and who can arrive at the arrival station of the reservation confirmation persons in the tolerable arrival period of the reservation confirmation persons.

6. The shared vehicle managing system according to claim 1, wherein the use application information includes ride-sharing approval information for approving ride-sharing, and
the reservation processing unit executes the ride-sharing vehicle allocation process in a case where the ride-sharing approval information of the use applicant is present, and selects the reservation confirmation person with whom the use applicant should share the ride from reservation confirmation persons whose ride-sharing approval information indicates approval of the ride-sharing.

7. The shared vehicle managing system according to claim 1, wherein the managing server is configured to give incentives to the use applicant and the reservation confirmation person whose ride-sharing has been confirmed.

8. The shared vehicle managing system according to claim 1, wherein the use application information further includes information about a number of driving approvers,
the reservation processing unit executes a divisional vehicle allocation process in a case where the remaining number of the shared vehicles in the departure station at the scheduled departure time of the use applicant is equal to or more than a second determination value and the remaining number of the shared vehicles in the arrival station at the scheduled arrival time of the use applicant is equal to or less than a third determination value, and
in the divisional vehicle allocation process, the reservation processing unit allocates the plurality of shared vehicles in the departure station to the use applicant in a case where the number of the driving approvers is plural.

9. A shared vehicle managing system for renting a plurality of shared vehicles located in a plurality of stations to a plurality of users, comprising:
a plurality of user terminals configured to generate use application information in response to an input operation by a use applicant, and
a managing server connected to the user terminals via a network,
wherein the use application information includes information about a departure station, an arrival station, a scheduled departure time, a scheduled arrival time, and a number of driving approvers,
the managing server includes a reservation processing unit configured to allocate at least one shared vehicle to the use applicant based on the use application information, and a station information acquiring unit configured to acquire a remaining number of the shared vehicles in each station at a freely-selected time,
the reservation processing unit executes a divisional vehicle allocation process in a case where the remaining number of the shared vehicles in the departure station at the scheduled departure time of the use applicant is equal to or more than a first determination value and the remaining number of the shared vehicles in the arrival station at the scheduled arrival time of the use applicant is equal to or less than a second determination value, and
in the divisional vehicle allocation process, the reservation processing unit allocates the plurality of shared vehicles in the departure station to the use applicant in a case where the number of the driving approvers is plural.

10. The shared vehicle managing system according to claim 8, wherein the use application information further includes divisional approval information for approving a divisional ride, and
in the divisional vehicle allocation process, the reservation processing unit allocates the plurality of shared vehicles in the departure station to the use applicant in a case where the number of the driving approvers is plural and the divisional approval information is present.

11. The shared vehicle managing system according to claim 8, wherein the managing server is configured to give an incentive to the use applicant who takes a divisional ride.

12. The shared vehicle managing system according to claim 9, wherein the use application information further includes divisional approval information for approving a divisional ride, and
in the divisional vehicle allocation process, the reservation processing unit allocates the plurality of shared vehicles in the departure station to the use applicant in a case where the number of the driving approvers is plural and the divisional approval information is present.

13. The shared vehicle managing system according to claim 9, wherein the managing server is configured to give an incentive to the use applicant who takes a divisional ride.
